(19) United States
(12) Patent Application Publication
(10) Pub. No.: US 2012/0256593 A1
(43) Pub. Date: Oct. 11, 2012

(54) Cell charge management system

(75) Inventor: Ioannis Milios, New York, NY (US)

(73) Assignee: SENDYNE CORP., New York, NY (US)

(21) Appl. No.: 13/516,732

(22) PCT Filed: Feb. 10, 2011
(86) PCT No.: PCT/IB11/50570

§ 371 Date: Jun. 16, 2012

Related U.S. Application Data
(60) Provisional application No. 61/303,138, filed on Feb. 10, 2010.

(51) Int. Cl. H02J 7/00

(52) U.S. Cl. 320/118

(57) ABSTRACT

A series array of electrochemical cells is charged by first applying a first charging current to the series array, thereby applying the first charging current to each of the cells in the series array. When one of the cells reaches a predefined maximum voltage, the series charging current is ceased. A second charging current is then selectively applied to various of the cells in the series array, topping up each of the cells in the series array. Priority is given to the weakest cell in the array. If there is an idle time for the battery load before the array is connected to a load, then charge is transferred from fully charged cells to weaker cells, thereby reducing charge imbalance among the cells. The array is connected to a load and power is drawn from the series array.

### BACKGROUND

It is not easy to balance the state of charge among cells in batteries consisting of cells.

Large batteries use large arrays of cells. A series connection (with or without other parallel connections) is required in specific applications, such as in electric vehicles, in order to meet the power requirements, because cells of specific chemistries exhibit high impedance. For this reason a battery for an electric vehicle might use 96 to 99 cells in series.

Any imbalance between and among cells greatly affects battery performance. When cells are in series, charging can be permitted to take place only until any one cell reaches Vmax (defined as a maximum cell voltage for a specific chemistry). If charging were to proceed beyond that point, the cell that is beyond Vmax would likely be damaged or start a runaway process that may cause fire and explosion of the battery.

When cells discharge (in a series connection), the discharge can be permitted to take place only until the first cell reaches Vmin (defined as the minimum cell voltage for a specific chemistry). If discharge were to proceed beyond that point, the cell that is below Vmin would likely be damaged or destroyed.

No matter how carefully they might be selected and matched during manufacturing, cells are never exactly identical to each other. After a battery has been used, the cells will eventually exhibit non-identical States of Charge (SOC). Cells self-discharge at non-identical rates due to heat distribution in the battery, which causes cells to be non-identical in temperature. Cell self-discharge is typically dependent upon temperature. For example with one cell chemistry the self-discharge rate may change by a factor of two for every 10° (Celsius) change in temperature. Other sources of imbalance may include aging of cells and load variations in control electronics.

Enormous amounts of time and energy have been given to the problem of balancing the state-of-charge among cells in a battery. No single approach has been widely adopted, perhaps in part because each approach proposed thus far has one disadvantage or another.

One prior-art approach is shown in FIG. 1. In this approach, bypass switches are provided, one for each cell in the battery. When the voltage of a particular cell reaches a value Vmax specified by the manufacturer, the corresponding switch is closed, so that no more charging current is applied to the cell. The charging current is then applied only to the remaining cells.

This approach was developed for small cell arrays. Where a large array is being used, the high currents employed could cause generation of unwanted heat and they may interfere with the safety of the charging process.

This approach is actually employed by some semiconductor manufacturers in small cell arrays.

Yet another approach provides bleed resistors that can be switched across individual cells. In this approach, when a particular cell reaches full charge, the bleed resistor is connected to that cell, thereby bleeding the highest-charged cell. After the cell has been bled, then the system restarts the charging of the battery.

This approach wastes energy, and heats the power pack. It significantly slows the charging process.

FIG. 2 shows a charge redistribution approach using capacitors. The approach is to transfer charge from a higher-charged cell to a lower-charged cell. It will be appreciated that this approach can be implemented during idle time or during discharge time, as well as during charging time. The efficiency though of this method is limited to 50% or less, and it is very poor when cell voltages are close to each other.

Various approaches are described in international patent publication WO 2010-117498 entitled “battery cell protection and conditioning circuit and system”, in international patent publication WO 2008-137764 entitled “fine-controlled battery-charging system”, or in U.S. Pat. No. 6,511,764 entitled “improved voltaic pile with charge equalizing system”. Yet another approach is U.S. Pat. No. 6,518,725 entitled “charge balancing system”.

Some of these approaches consume energy, or are slow in large arrays, or depend on voltage differences which happen only at the end of a charging cycle.

Yet another approach is shown in FIG. 3. This approach uses inductive redistribution. It is complicated and is expensive to implement and since charge has to be carried through multiple cells its efficiency is low.

Still another approach is shown in FIG. 4. It uses dedicated chargers, one for each cell. This balancing only takes place during charge (not during discharge). The implementation is difficult, and is costly if the cell array is large.

It would be very helpful if a charge balancing approach could be found that would avoid some or all of the disadvantages just described.

### SUMMARY OF THE INVENTION

A series array of electrochemical cells is charged by first applying a first charging current to the series array, thereby applying the first charging current to each of the cells in the series array. When one of the cells reaches a predefined maximum voltage, the series charging current is ceased. A second charging current is then selectively applied to various of the cells in the series array, topping up each of the cells in the series array. Priority is given to the weakest cell in the array. Anytime there is an idle time between a load activity, then charge is transferred from stronger cells to or from the whole battery array to weaker cells, thereby reducing charge imbalance among the cells. The array is connected to a load and power is drawn from the series array.

### DESCRIPTION OF THE DRAWING

The invention will be described with reference to a drawing in several figures, of which:

FIG. 1 shows a first prior-art approach for balancing of cells;

FIG. 2 shows a second prior-art approach for balancing of cells;

FIG. 3 shows a third prior-art approach for balancing of cells;

FIG. 4 shows a fourth prior-art approach for balancing of cells; and

FIG. 5 shows an embodiment according to the invention for balancing of cells.

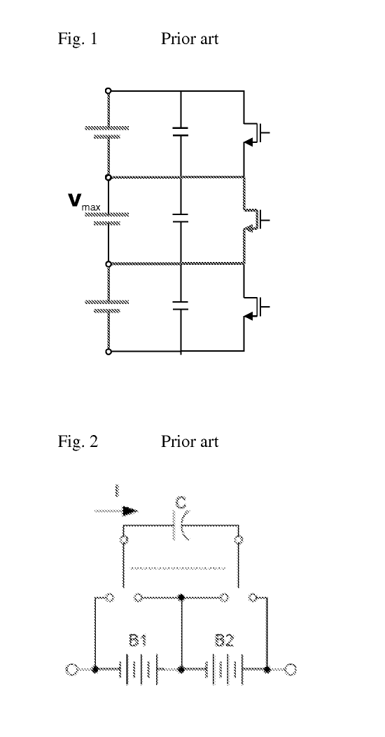

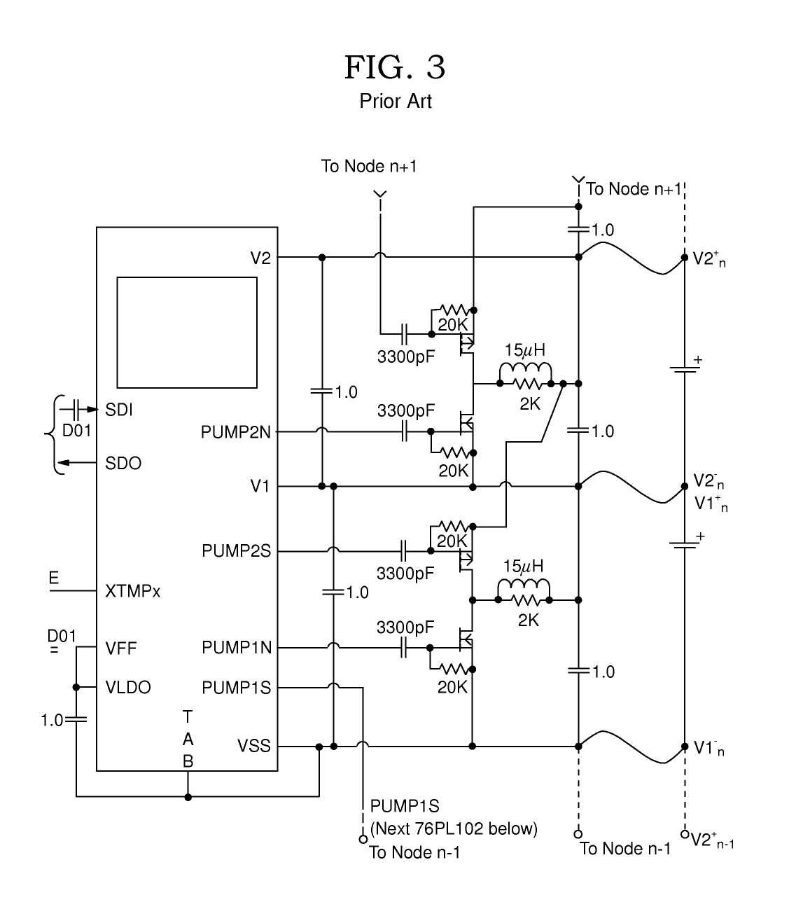

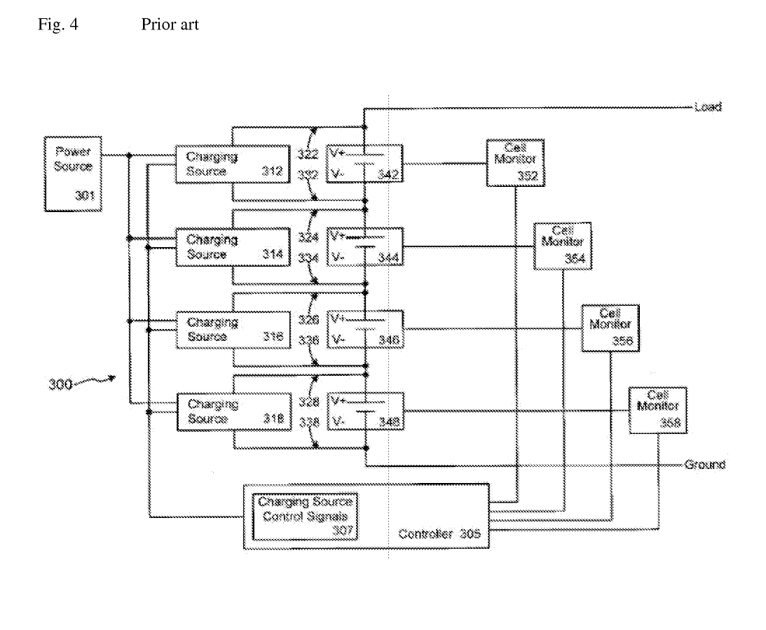

### DETAILED DESCRIPTION

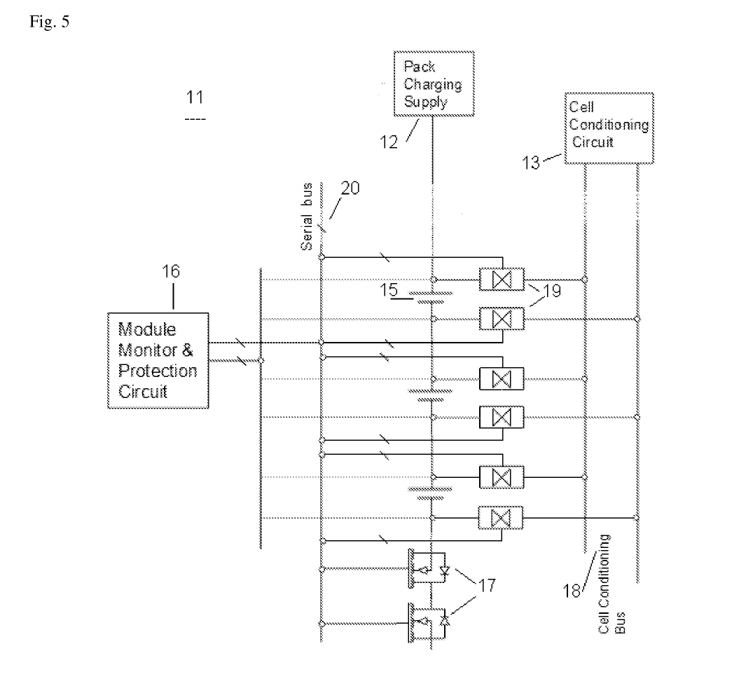

The invention will be discussed and described with respect to an exemplary apparatus 11 shown in FIG. 5. The apparatus 11 includes a series-connected array of cells of which cell 14 is exemplary. In the apparatus 11, a two-wire cell conditioning bus 18 connects to a cell conditioning circuit 13. The cell conditioning circuit 13 is powered either by the pack charging supply 12 when online or by elements of the cell array when offline. The cell conditioning circuit 13 is independent from the main power path along the series array of cells.

The cells (for example cell 14) are each connected to the bus 18 through respective analog switches (for example 19) which may be FETs. The switches are controlled by the module monitor and protection circuit 16 either directly or through a serial bus 20. The analog switches can be either discrete or embedded in the module monitor and protection circuit 16.

### During Charging

When any cell reaches end of charge (that is, when it reaches a Vmax), the circuit 16 ceases the series-connected charging process by opening switch 17. It is assumed that at least one cell will not yet, at this point, have reached maximum state-of-charge. Any such cell that has not reached maximum state-of-charge (such as cell 15 for example) is sequentially connected through switches (such as switches 19) to the cell conditioning circuit 13 to complete the charging process.

To the extent that any one cell is known to be or is thought to be the “weakest” cell, priority is given to charging that cell over other cells.

### During Idle

When no charging is taking place, the circuit 16 carries out measurements and calculations that are intended to measure or to estimate the state of charge for each cell. The circuit 16 redistributes charge from one or another of the cells in the series array through the circuit 13 to any weaker cell. This process continues until the total available charge is distributed equally (or as equally as is possible to achieve) among the cells in the series array.

Later the series array will be charged again, and cell imbalance within the array will be smaller than if the redistribution had not taken place.

During Use The cell array is then placed into service, providing current to a load omitted for clarity from FIG. 5.

Later the charging process is repeated.

### The Cell Conditioning Circuit

The cell condition circuit may be a floating power supply that actively draws power from elsewhere, for example:
from the entirety of the module (entire series of the string of cells), or
from the charging current supplied from external to the module.

The cell conditioning circuit can also be as simple as a capacitor or an electrochemical cell.

Those skilled in the art will have no difficulty devising myriad obvious variants and improvements upon the invention without deviating in any way from the invention. All such obvious variants and improvements are intended to be encompassed within the claims which follow.

1. A method for use with a series array of electrochemical cells, each cell having a respective state of charge, each cell electrically coupled to a cell conditioning circuit by means of respective switches, the method comprising the steps of:
applying a first charging current to the series array, thereby applying the first charging current to each of the cells in the series array;
measuring a voltage at each of the cells, thereby developing information indicative of the state of charge of each of the cells;
when a predetermined state-of-charge condition is observed in the information indicative of the state of charge of a first one of the cells, ceasing the application of the first charging current to the series array;
after the ceasing of the application of the first charging current to the series array, applying a second charging current to a second one of the cells by means of its respective switches, the second one of the cells differing from the first one of the cells;
ceasing the application of the second charging current to the second one of the cells;
after the ceasing of the application of the first charging current to the series array, and after the ceasing of the application of the second charging current to the second one of the cells, applying a third charging current to a third one of the cells by means of its respective switches, the third one of the cells differing from the first one of the cells and differing from the second one of the cells;
ceasing the application of the third charging current to the third one of the cells;
after the ceasing of the application of the first charging current to the series array, and after the ceasing of the application of the second charging current to the second one of the cells, and after the ceasing of the application of the third charging current to the third one of the cells, connecting the series array of cells with a load, thereby delivering power to the load.

2. The method of claim 1 further comprising the steps, performed between the step of ceasing the application of the third charging current to the third one of the cells and the step of connecting the series array of cells with a load, of:
by means of the respective switches of the cells, redistributing charge from a fourth one of the cells to a fifth one of the cells, the fourth cell differing from the fifth cell, whereby the redistribution of charge reduces state-of-charge imbalance between the fourth and fifth cells.

3. The method of claim 2 wherein the cell conditioning circuit comprises a capacitor.

4. The method of claim 3 wherein the cell conditioning circuit draws power from the series array of cells.

5. The method of claim 3 wherein the first charging current has a respective source, and wherein the cell conditioning circuit draws power from the source of the first charging current.

6. The method of claim 1 wherein the predetermined state-of-charge condition comprises reaching a predetermined voltage value at the first one of the cells.
